(19) United States
(12) Patent Application Publication
(10) Pub. No.: US 2012/0180575 A1
(43) Pub. Date: Jul. 19, 2012

(54) CAPACITANCE-TYPE FORCE SENSOR

(75) Inventors: Tetsuro SAKANO, Minamitsuru-gun (JP); Youichi INOUE, Minamitsuru-gun (JP)

(73) Assignee: FANUC CORPORATION, Minamitsuru-gun (JP)

(21) Appl. No.: 13/287,489

(22) Filed: Nov. 2, 2011

(30) Foreign Application Priority Data
Jan. 13, 2011 (JP) 2011-005057

(51) Int. Cl. G01L 1/14

(52) U.S. Cl. 73/862.626

(57) ABSTRACT

A capacitance-type force sensor is provided with a fixed plate, a fixed portion on which the fixed plate is mounted, a load transmission portion, and an elastic portion through which the load transmission portion is mounted on the fixed portion. All these members are formed of materials having substantially equal coefficients of linear expansion. Further, a displacement electrode secured to the load transmission portion and/or a fixed electrode secured to the fixed plate is divided into three or more electrically independent electrodes such that the displacement and fixed electrodes form three or more capacitance elements.

### BACKGROUND OF THE INVENTION

1. Field of the Invention

The present invention relates to a capacitance-type force sensor configured to detect deformation of a sensor body caused by an applied force, based on a capacitance, and calculate and output applied force components and moment components based on the detected capacitance.

2. Description of the Related Art

With the sophistication of robotics, there is an increasing demand for force sensors configured to detect force components along a plurality of axes and moments around a plurality of axes, in order to appropriately control forces generated by robots. These force sensors include a strain-gauge type and capacitance type. A force sensor of the strain-gauge type is a system in which distortion of a sensor body is detected by means of a strain and applied force/moment components are calculated and output based on the detected distortion. According to this system, the force/moment components of plural axes can be calculated by detecting the distortion of the sensor body at a plurality of spots. Thus, the force sensor of this type outputs six axial components in total, including force components along three orthogonal linear axes and moment components around the axes.

A force sensor of the capacitance type is a system in which deformation of a sensor body caused by an applied force is detected based on a capacitance and applied force/moment components are calculated and output based on the detected capacitance. According to this system, detectable force/moment components are restricted to three axial components, so that the resulting force sensor is simple in structure and very low-priced.

In a force detection device described in Japanese Patent Application Laid-Open No. 4-148833, a fixed substrate and a flexible substrate are opposed to each other and secured to a housing of the device, and a capacitance element is formed using two electrodes. One of the electrodes is formed on that surface of the fixed substrate which faces the flexible substrate, and the other electrode is formed on that surface of the flexible substrate which faces the fixed electrode. If an external force is applied to an acting body on the flexible substrate, the flexible substrate is deflected so that a capacitance changes accordingly. As a result, by detecting the capacitance, the external force applied can be detected as multi-axial force components.

Described in Japanese Patent Application Laid-Open No. 2001-27570 is a capacitance-type force sensor configured so that a diaphragm portion and a movable electrode plate are formed of an electrically conductive elastomer such that the movable electrode plate is deflected by a force applied to an operating portion.

The force sensor of the strain-gauge type is configured so that strain gauges are bonded to a plurality of portions of the sensor body. In this case, the structure of the sensor body is complicated, and the bonding operation requires many man-hours, thus entailing high costs.

The capacitance-type force sensor is configured so that displacement is caused to change a capacitance by an external force and the applied force is detected by detecting the capacitance.

The basic structure of the capacitance-type force sensor is disclosed in Japanese Patent Application Laid-Open No. 4-148833 described above. In this structure, the flexible substrate is deflected so that the capacitance changes if subjected to an external force. In this case, the capacitance-type force sensor is used as an acceleration sensor, which is supposed to be rather small and capable of detecting only small forces. If the sensor is larger and capable of detecting larger forces, the flexible substrate with a simple shape cannot easily obtain good deflection characteristics, so that it is difficult to achieve high detection accuracy. The device housing may be formed of a material different from those of the flexible and fixed substrates. If the ambient temperature changes, in this case, the flexible and fixed substrates come under a compressive or extensive force from the device housing due to a different expansion caused by the different coefficient of linear expansion between the materials, so that these flexible and fixed substrates are deflected. If a force sensor is large in shape, a difference in thermal expansion is increased, as a result, deflection of the flexible and fixed substrates occurs, although if the force sensor is small enough, such deflection is negligible. Since the capacitance changes due to this deflection, detected values vary, resulting in a reduction in the stability of detection.

Since the structure of the capacitance-type force sensor is simple, the sensor body sometimes may be formed of an elastomer. If the sensor body is formed of an elastomer, it cannot resist large forces, so that it is difficult to manufacture a force sensor capable of detecting strong forces. Since the sensor body is not easily restorable if it is deformed by a force, the detection accuracy is poor. The elastomer is highly thermally expansive and changes so much in shape and properties over years that it cannot realize a high-precision force sensor.

### SUMMARY OF THE INVENTION

Accordingly, the object of the present invention is to provide a low-priced capacitance-type force sensor with a simple structure, capable of dealing with small to large forces and having a good detection accuracy and good detection stability with regard to temperature changes.

A capacitance-type force sensor according to the present invention comprises: a fixed portion fixedly mounted on an external device or a base; a load attachment portion for mounting an object on which an external force acts; a load transmission portion configured to transmit a force applied to the load attachment portion; an elastic portion formed between the fixed portion and the load transmission portion; a fixed plate mounted on the fixed portion; a displacement electrode formed on that surface of the load transmission portion which faces the fixed plate; and a fixed electrode formed on that surface of the fixed plate which faces the load transmission portion. One or both of the displacement and fixed electrodes is divided into three or more electrically independent electrodes such that the displacement and fixed electrodes form three or more capacitance elements. The fixed portion, the load transmission portion, the elastic portion and the fixed plate are formed of materials having substantially equal coefficients of linear expansion such that differences in thermal expansion between the constituent members of the force sensor are reduced. The capacitances of the three or more capacitance elements are detected so that one or more force components along one or more axes and/or one or more moment components around one or more axes is detectable.

The load attachment portion may comprise a flange portion projecting outside the load transmission portion, and a mounting hole or a threaded hole may be formed in the flange portion.

The load transmission portion and/or the fixed plate may be formed of a metallic material and is replaced with a metallic material which constitutes one of the displacement and fixed electrodes.

According to the present invention arranged in this manner, there may be provided a low-priced capacitance-type force sensor with a simple structure, capable of dealing with large and small forces and of reliable detection of temperature changes with excellent accuracy.

### BRIEF DESCRIPTION OF THE DRAWINGS

The above and other objects and features of the present invention will be obvious from the ensuing description of embodiments with reference to the accompanying drawings, in which:

FIG. 1 is a side sectional view showing a first embodiment of a capacitance-type force sensor according to the present invention;

FIG. 2 is a top view of the force sensor shown in FIG. 1;

FIG. 3 is a view of a fixed electrode of the force sensor of FIG. 1 taken from the side of a displacement electrode;

FIG. 4 is a view of the displacement electrode of the force sensor of FIG. 1 taken from the side of the fixed electrode;

FIG. 5 is a view showing how a force along a linear axis (Z-axis) is applied to the force sensor of FIG. 1;

FIG. 6 is a view showing how a moment around a Y-axis is applied to the force sensor of FIG. 1;

FIG. 7 is a side sectional view showing a second embodiment of the capacitance-type force sensor according to the present invention;

FIG. 8 is a top view of the force sensor shown in FIG. 7; and

FIG. 9 is a side sectional view showing a third embodiment of the capacitance-type force sensor according to the present invention.

### DETAILED DESCRIPTION OF THE PREFERRED EMBODIMENTS

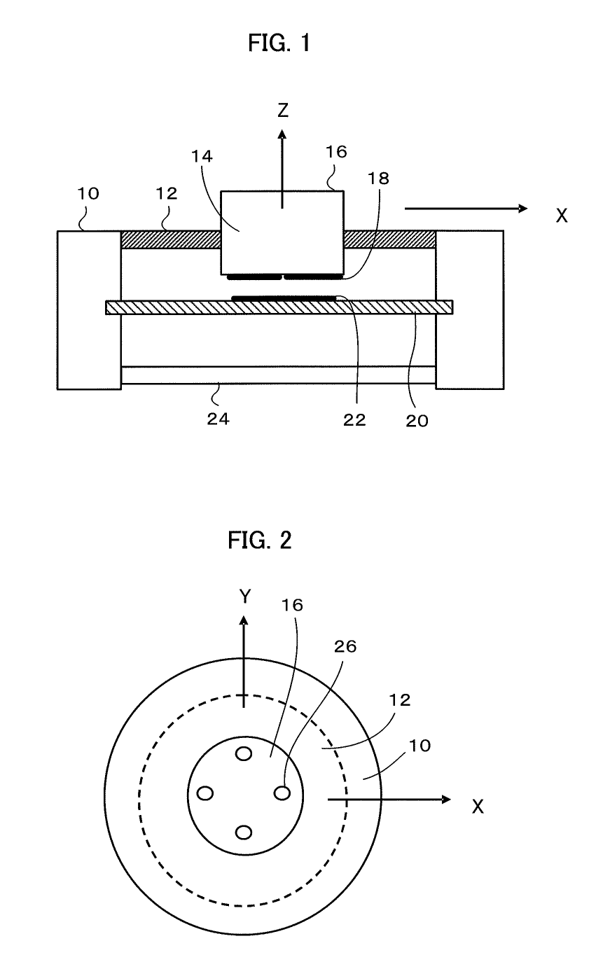

A first embodiment of a capacitance-type force sensor according to the present invention will first be described with reference to FIG. 1.

A capacitance-type force sensor 1 according to this embodiment comprises a fixed portion 10, load attachment portion 16, and load transmission portion 14. The fixed portion 10 is fixedly mounted on an external device (not shown) such as a robot arm. A loading mechanism (e.g., a chuck, robot hand, etc.) that is subject to external forces is mounted on the load attachment portion 16. The load transmission portion 14 is connected to the load attachment portion 16 and serves to transmit a force applied thereto. An elastic portion 12 is formed between the load transmission portion 14 and the fixed portion 10. The elastic portion 12 is elastically deformed by an external force, whereupon the load transmission portion 14 is displaced.

The properties of the elastic portion 12 are very important factors that determine those of the force sensor. If the strength of the elastic portion 12 is large, it is displaced little, so that the detection sensitivity is reduced. Even if it is subjected to a great force, however, the elastic portion 12 cannot be easily broken. If the strength of the elastic portion 12 is small, in contrast, its displacement increases, so that the detection sensitivity increases. If subjected to an excessive force in this case, however, the elastic portion 12 is easily broken. Thus, a sensor that can deal with various maximum loads can be realized by changing the strength of the elastic portion 12. In general, the elastic portion 12 is formed of a thin, plate-like structure called the diaphragm. However, the diaphragm may be partially made thinner or undulated like a bellows, and its shape according to the present invention is not particularly limited.

Preferably, the fixed portion 10, elastic portion 12, load transmission portion 14, and load attachment portion 16 should be in the form of an integral metal structure. Such an integral metal structure, being formed of the same material (metal), is free from deformation due to thermal expansion or contraction. The metallic material used in the manufacture of the integral structure is also an important factor. Although high-strength steel can overcome a great force, its Young's modulus is so high that the elastic portion 12 cannot be displaced much when subjected to a force unless it is made thinner. Accordingly, machining the elastic portion 12 requires high accuracy, thus entailing an increase in cost. If a high-strength aluminum alloy such as super duralumin, whose Young's modulus is about a third that of steel, is used, the elastic portion 12 can be displaced much and made lighter, so that desirable properties for the force sensor can be obtained.

A fixed plate 20 is attached to the fixed portion 10, a displacement electrode 18 is formed on that surface of the load transmission portion 14 which faces the fixed plate 20, and a fixed electrode 22 is formed on that surface of the fixed plate 20 which faces the load transmission portion 14. If a difference in thermal expansion is caused between the fixed plate 20 and the fixed portion 10, the fixed plate 20 is warped or deflected, so that the distance between the electrodes varies. Therefore, the fixed plate 20 and the fixed portion 10 should be formed of the same material or of materials having substantially equal coefficients of linear expansion. While there are various types of aluminum alloys, for example, their coefficients of linear expansion are substantially equal.

Accordingly, the variation of the inter-electrode distance due to the difference in thermal expansion can be prevented if high-strength super duralumin is used for the fixed portion 10, elastic portion 12, and load transmission portion 14, and a low-priced conventional aluminum alloy is used for the fixed plate 20 that cannot be subjected to any special force. A lid 24 is a member that protects the fixed plate 20 from the external atmosphere. If the lid 24, like the fixed plate 20, is formed of an aluminum alloy, it can prevent the other members from being affected by thermal expansion or contraction.

A detection circuit (not shown) is electrically connected to the displacement electrode 18 and the fixed electrode 22. The detection circuit detects the capacitances of capacitance elements formed between the displacement electrode 18 and the fixed electrode 22, and calculates and outputs force components and moment components based on the detected capacitances. The load transmission portion 14 and the displacement electrode 18 are displaced by an external force, and the capacitances vary corresponding to the displacement. Thus, a force component of the external force along a linear axis (Z-axis, described later) and moment components around axes (X- and Y-axes, described later) perpendicular to the linear axis can be calculated based on the detected capacitances.

FIG. 2 is a top view of the capacitance-type force sensor 1 shown in FIG. 1. The force sensor 1 has a cylindrical external shape, and the load attachment portion 16 has a circular cross-section. Two orthogonal axes that cross each other at the center of the circle of the load attachment portion 16 are defined as the X- and Y-axes, as shown in FIG. 2, and an axis in the direction perpendicular to both the X- and Y-axes (i.e., perpendicular to the drawing plane of FIG. 2) is defined as the Z-axis.

Threaded mounting holes 26 are formed in the load attachment portion 16. They are used in mounting the loading mechanism (not shown), such as a chuck or robot hand, by bolts or the like.

If the external shape of the capacitance-type force sensor 1 is given the illustrated cylindrical external shape, the fixed portion 10, elastic portion 12, load transmission portion 14, and the like can be easily and accurately lathed as an integral structure. Since a circular cylinder is symmetrical with respect to its center axis, the properties in the X- and Y-axis directions are equal, so that a high-precision capacitance-type force sensor can be realized easily. However, the capacitance-type force sensor 1 need not be restricted to the cylindrical external shape, and may alternatively be polygonal (e.g., square) as viewed from above.

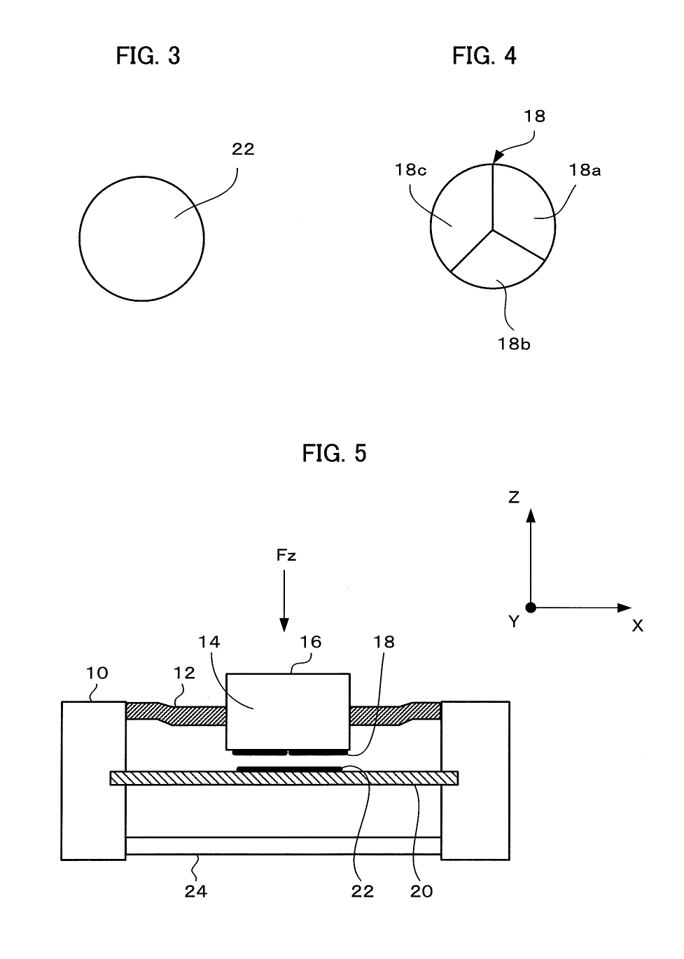

FIG. 3 is a view of the fixed electrode 22 of the capacitance-type force sensor of FIG. 1 taken from the side of the displacement electrode 18. As shown in FIG. 3, the fixed electrode 22 is formed of a single electrode.

FIG. 4 is a view of the displacement electrode 18 of the capacitance-type force sensor of FIG. 1 taken from the side of the fixed electrode 22. The displacement electrode 18 comprises three equally-divided electrodes 18a, 18b and 18c. Since the displacement electrode 18 is divided into three parts, three capacitance elements are formed. Since the capacitance is proportional to the electrode area and inversely proportional to the gap distance, it changes if the displacement electrode 18 is displaced so that the gap distance changes. The linear force component along the Z-axis and the moment components around the X- and Y-axes can be detected by detecting the capacitances of the three capacitance elements. Although the fixed electrode 22 is formed of a single electrode in the example shown in FIG. 3, it may be formed of a plurality of divided electrodes. While the displacement electrode 18 is divided into three parts, it may alternatively be divided into four or more parts. Alternatively, moreover, the displacement electrode 18 may be formed of a single central electrode and divided electrodes arranged around it or of a single ring-shaped electrode and divided electrodes inside it. In short, the shape, number of divisions, and layout of the electrodes may be varied in several ways. Further, the respective shapes of the fixed electrode 22 and the displacement electrode 18 may be replaced with each other.

If the load transmission portion 14 and the fixed plate 20 are each formed of a metal, the displacement electrode 18 and the fixed electrode 22 should be insulated from the metal that constitutes the load transmission portion 14 and the fixed plate 20. The electrodes (displacement and fixed electrodes 18 and 22) must be electrically connected to the detection circuit. To this end, there is a simple, low-cost method for electrode formation in which an electrode is formed of a flexible printed circuit, which is bonded to the load transmission portion 14 or the fixed plate 20. An aluminum board is constructed such that an insulating layer is formed on a surface of an aluminum plate and the electrode is formed on the insulating layer. This is a convenient electrode forming method if the aluminum board is used for the fixed plate 20 on which the electrode is formed.

In the case where only a single electrode is used, as shown in FIG. 3, the electrode can be formed by bonding a thin metal plate to the fixed plate 20 with an insulating sheet therebetween or by joining the plates by means of plastic screws. Thus, various methods may possibly be used for electrode formation, and the present invention is not limited to any special one of those methods.

FIG. 5 is a view showing how a force Fz along the linear axis (Z-axis) is applied to the force sensor of FIG. 1. In this case, the load transmission portion 14 is translationally displaced along the Z-axis, so that the capacitances of all the three divided electrodes change in the same way.

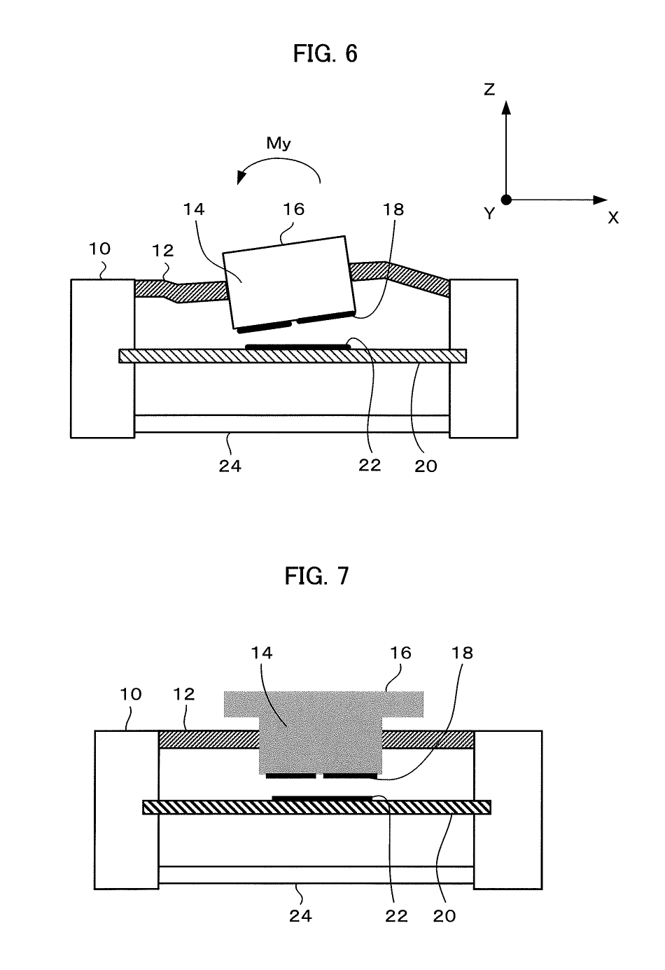

FIG. 6 is a view showing how a moment My around the Y-axis is applied to the force sensor of FIG. 1. In this case, the load transmission portion 14 is rotationally displaced around the Y-axis, so that the capacitances of the three divided electrodes (FIG. 4) change in different ways. At least three capacitances must be detected in order to obtain the force component along the Z-axis and the moments around the X- and Y-axes, three components in total. The three force/moment components can be obtained from the three or more capacitances by previously obtaining a transformation matrix by an operation called calibration and multiplying the transformation matrix by the capacitances. In the calibration, various types of forces the three force/moment components of which are all known are applied to the force sensor, the detected capacitances are recorded, and the transformation matrix is obtained by arithmetic operations based on the correlations between the capacitances and the three force/moment components applied. Since these calculation techniques are well-known mathematical techniques, a detailed description thereof is omitted. According to this method, the capacitances as input variables should only be three or more in number, and the obtained transformation matrix reflects all factors that determine the properties of the force sensor, such as the areas, shapes, layouts, etc., of the electrodes. Thus, according to the present invention, the electrodes are not specially restricted in number, shape, etc., only if they are three or more in number.

FIG. 7 is a side sectional view showing a second embodiment of the capacitance-type force sensor according to the present invention. This embodiment differs from the capacitance-type force sensor of the first embodiment shown in FIG. 1 in that a load attachment portion 16 is in the form of a flange projecting outside a load transmission portion 14.

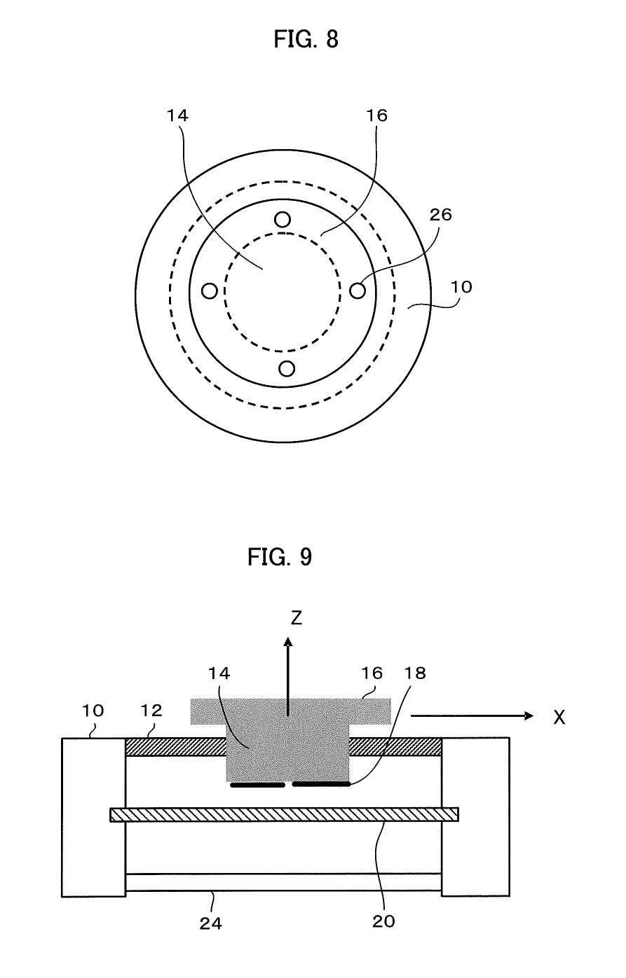

FIG. 8 is a top view of the capacitance-type force sensor shown in FIG. 7. As shown in FIG. 8, threaded mounting holes 26 are formed in a flange portion of the load attachment portion 16.

When a loading mechanism such as a robot hand, which is subject to an external force, is fastened to the load attachment portion 16 of the capacitance-type force sensor 1 by bolts, high compressive stress is produced around threaded holes by bolt tightening. In the case where the force sensor 1 is formed of an aluminum alloy, in particular, the aluminum alloy around the threaded holes, whose Young's modulus is as low as about a third that of steel, is greatly distorted by the compressive stress when the bolts are tightened. In the capacitance-type force sensor with its load attachment portion 16 constructed in the manner shown in FIG. 1, the distortion occurs in the load transmission portion 14 of the load attachment portion 16, so that the elastic portion 12 connected to the load transmission portion 14 is also distorted, and hence, its elastic modulus changes. The elastic modulus of the elastic portion 12 is an important factor that determines the amount of displacement of the load transmission portion 14 caused by the external force. The detection accuracy is reduced if the elastic modulus changes.

If the load attachment portion 16 is constructed in the manner shown in FIG. 7, the distortion is absorbed by the flange portion, so that the load transmission portion 14 is hardly distorted. Therefore, the elastic portion 12 that connects the load transmission portion 14 and the fixed portion 10 is not affected, so that degradation of the detection accuracy can be prevented.

FIG. 9 is a side sectional view showing a third embodiment of the capacitance-type force sensor according to the present invention. This embodiment differs from the capacitance-type force sensor of the second embodiment shown in FIG. 7 in that a fixed electrode 22 is not provided on a fixed plate 20.

There are two types of capacitance detection circuits, double-electrode and single-electrode. In the double-electrode system, neither of two electrodes that form capacitances is set at the ground potential. In the single-electrode system, one of the two electrodes is set at the ground potential. In general, the double-electrode system is more resistant to induction noise than the single-electrode system and is not affected by stray capacitances with respect the ground, so that its detection sensitivity and stability are satisfactory. In contrast, the single-electrode system does not require the formation of one of the electrodes, so that it has advantages of a simpler structure of the force sensor and lower cost.

In the embodiment shown in FIG. 9, the single-electrode system is adopted, and the fixed plate 20 of a metallic material is connected to the ground potential. If this is done, the fixed electrode 22 need not be provided.

According to the capacitance-type force sensor of the present invention, as described above, the elastic portion is disposed between the fixed portion and the load transmission portion, and the elastic portion is elastically deformed so that the load transmission portion is displaced when subjected to an external force. This elastic portion is an important part that determines the properties of the force sensor, and external forces of various magnitudes can be overcome by appropriately designing the elastic portion. If the strength of the elastic portion is increased, the force sensor becomes sturdy and sustainable. If the strength is reduced, in contrast, the detection sensitivity of the force sensor is enhanced.

As the ambient temperature changes, the constituent members of the force sensor thermally expand or contract. If there are differences in thermal expansion between the constituent members of the force sensor, stress occurs, whereupon the elastic portion or the fixed plate is deflected. Accordingly, the distance between the fixed electrode and the displacement electrode varies, so that the detected value of the force sensor varies. To prevent this, the fixed plate, elastic portion, and load transmission portion should preferably be integrally formed of the same material. Likewise, the deflection of the fixed plate due to a difference in thermal expansion, and hence, the variation of the inter-electrode distance, can be prevented by using the same material or materials having substantially equal coefficients of linear expansion for the fixed plate and the fixed portion.

The loading mechanism, such as a chuck or robot hand for holding a workpiece, is fastened to the load attachment portion by bolts. Tightening of these bolts produces high stress around the threaded holes, and the stress causes the load transmission portion to be distorted. Consequently, the elastic portion that is connected to the load transmission portion is also distorted, so that the elastic modulus of the elastic portion changes, resulting in a reduction in detection accuracy. If the threaded holes for bolt-fastening are formed in the flange portion that projects like a hat brim outside the load transmission portion, the flange portion can absorb the stress produced by the bolt tightening and eliminate the influence on the elastic portion. Thus, the detection accuracy can be maintained satisfactorily.

With use of the single-electrode system as the circuit system for capacitance detection, moreover, one of the electrodes that form the capacitances need not be deliberately provided, and hence, the force sensor can be made low-priced, if the constituent members of the force sensor are metallic structures that are connected to the ground potential.

1. A capacitance-type force sensor comprising:
a fixed portion fixedly mounted on an external device or a base;
a load attachment portion for mounting an object on which an external force acts;
a load transmission portion configured to transmit a force applied to the load attachment portion;
an elastic portion formed between the fixed portion and the load transmission portion;
a fixed plate mounted on the fixed portion;
a displacement electrode formed on that surface of the load transmission portion which faces the fixed plate; and
a fixed electrode formed on that surface of the fixed plate which faces the load transmission portion,
wherein one or both of the displacement and fixed electrodes is divided into three or more electrically independent electrodes such that the displacement and fixed electrodes form three or more capacitance elements,
the fixed portion, the load transmission portion, the elastic portion and the fixed plate are formed of materials having substantially equal coefficients of linear expansion such that differences in thermal expansion between the constituent members of the force sensor are reduced, and
the capacitances of the three or more capacitance elements are detected so that one or more force components along one or more axes and/or one or more moment components around one or more axes is detectable.

2. The capacitance-type force sensor according to claim 1, wherein the load attachment portion comprises a flange portion projecting outside the load transmission portion, and a mounting hole or a threaded hole is formed in the flange portion.

3. The capacitance-type force sensor according to claim 1, wherein the load transmission portion and/or the fixed plate is formed of a metallic material and is replaced with a metallic material which constitutes one of the displacement and fixed electrodes.

4. The capacitance-type force sensor according to claim 1, wherein the fixed portion, the elastic portion, the load transmission portion and the load attachment portion are formed into an integral structure of the same metallic material such that the integral structure is free from deformation due to thermal expansion or contraction.

5. The capacitance-type force sensor according to claim 4, wherein the fixed plate is formed of a metallic material having a coefficient of linear expansion substantially equal to that of the metallic material which constitutes the integral structure lest a difference in thermal expansion occur between the fixed plate and the fixed portion and cause the fixed plate to be warped or deflected.
